(19) United States
(12) Patent Application Publication
(10) Pub. No.: US 2025/0158196 A1
(43) Pub. Date: May 15, 2025

(54) BATTERY MODULE

(71) Applicant: TOYOTA JIDOSHA KABUSHIKI KAISHA, Toyota-shi (JP)

(72) Inventors: Tomoya Mesuda, Nisshin-shi (JP); Seigo Fujishima, Miyoshi-shi (JP); Yoshiro Obayashi, Toyota-shi (JP); Kosuke Suzuki, Toyota-shi (JP); Takeru Hara, Toyota-shi (JP); Satoshi Moriyama, Nagoya-shi (JP); Kenta Miyahara, Toyohashi-shi (JP)

(73) Assignee: TOYOTA JIDOSHA KABUSHIKI KAISHA, Toyota-shi (JP)

(21) Appl. No.: 18/768,460

(22) Filed: Jul. 10, 2024

(30) Foreign Application Priority Data
Nov. 9, 2023 (JP) 2023-191796

(51) Int. Cl. H01M 50/242; B60L 50/64; H01M 50/209

(52) U.S. Cl. CPC H01M 50/242; B60L 50/64; H01M 50/209; H01M 2220/20

(57) ABSTRACT

A battery module includes elongated battery cells each formed by sealing an electrode body with a laminate film, and a case capable of accommodating a battery cell group in which a plurality of the battery cells are arranged, wherein the case is configured to include a pair of short side wall portions extending along a lamination direction of the battery cells, and a pair of long side wall portions that connect the short side wall portions to each other, and the long side wall portions are formed in a shape that is more difficult to deform in a plate thickness direction than the short side wall portions.

### CROSS-REFERENCE TO RELATED APPLICATION

This application claims priority to Japanese Patent Application No. 2023-191796 filed on Nov. 9, 2023, incorporated herein by reference in its entirety.

### BACKGROUND

### 1. Technical Field

The disclosure relates to a battery module.

### 2. Description of Related Art

US 2018/287184 A discloses a battery module in which an electrode assembly is accommodated in a case. Furthermore, the battery module has a structure in which thermal expansion of the electrode assembly is suppressed by surrounding the outside of the electrode assembly with a heat-shrinkable protective layer.

### SUMMARY

However, the number of manufacturing steps and the cost increase due to formation of a heat-shrinkable protective layer as compared with a structure in which no heat-shrinkable protective layer is formed.

The present disclosure takes the above facts into consideration, and has an object to obtain a battery module that can suppress thermal expansion while suppressing increase in the number of manufacturing steps and the cost.

A battery module according to claim 1 includes elongated battery cells each formed by sealing an electrode body with a laminate film, and a case capable of accommodating a battery cell group in which a plurality of the battery cells is arranged, wherein the case is configured to include a pair of short side wall portions extending along a lamination direction of the battery cells, and a pair of long side wall portions that connect the short side wall portions, and the long side wall portions are formed in a shape that is more difficult to deform in a plate thickness direction than the short side wall portions.

In the battery module according to claim 1, the battery cell is formed by sealing an electrode body with a laminate film, and has an elongated shape. Furthermore, the case is capable of accommodating the battery cell group in which a plurality of battery cells are arranged. Here, the case is configured to include a pair of short side wall portions extending along the lamination direction of the battery cells, and a pair of long side wall portions that connect the short side wall portions, and the long side wall portions are formed in a shape that is more difficult to deform in the thickness direction than the short side wall portions. As a result, when the battery cells thermally expand, reaction force is applied to the battery cells from the long side wall portions of the case, whereby the thermal expansion of the battery cells can be suppressed. Furthermore, since the long side wall portions of the case are formed in a shape that is difficult to deform in the thickness direction to suppress the thermal expansion of the battery cells, there is no need for a dedicated member such as a heat-shrinkable protective layer.

According to the battery module of claim 2, in claim 1, the short side wall portions may be formed in a linear shape, and the longitudinal side wall portions may be formed in such a shape that the center portions in the longitudinal direction thereof are convex inward.

In the battery module according to claim 2, the center portions of the long side wall portions in the longitudinal direction are convex inward. Since the central portions of the battery cells in the longitudinal direction tend to expand during thermal expansion, the thermal expansion of the battery cells can be effectively restrained by bringing the central portions of the long side wall portions in the longitudinal direction into contact with the battery cell group.

According to the battery module of claim 3, in claim 2, the center portions of the long side wall portions in the longitudinal direction may be in contact with the battery cell group in an unloaded state.

In the battery module according to claim 3, since the long side wall portions are in contact with the battery cell group in an unloaded state, restraining pressure can be applied to the battery cell group by the long side wall portions.

According to the battery module of claim 4, in claim 1, the long side wall portions may be formed such that the center portions in the longitudinal direction thereof are formed to be thicker than the other portions.

In the battery module according to claim 4, since the center portions in the longitudinal direction of the long side wall portions are thick, the strength is higher than that of the other portions. As a result, the weight can be reduced as compared with a case in which the entire long side wall portions are made thick while excellently receiving the force from the battery cells during thermal expansion of the battery cells.

According to the battery module of claim 5, in claim 1, connection portions of the long side wall portions to be connected to the short side wall portions may be formed to be thicker than the other portions.

In the battery module according to claim 5, even when a load is applied from the battery cell to the long side wall portion during thermal expansion and the load is concentrated at the connection portion between the long side wall portion and the short side wall portion, it is possible to restrict deformation because the connection portion between the long side wall portion and the short side wall portion is thicker than the other portions.

As described above, according to the battery module of the present disclosure, thermal expansion can be restrained while suppressing increases in the number of manufacturing steps and the cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view showing a main portion of a vehicle to which a battery pack according to a first embodiment is applied;

FIG. 2 is a schematic perspective view of a battery module according to the first embodiment;

FIG. 3 is a schematic diagram of a battery cell accommodated in the battery module according to the first embodiment as viewed from a thickness direction;

FIG. 4 is a plan view of the battery module according to the first embodiment in a state in which an upper cover of the battery module is removed;

FIG. 5 is a plan view of a battery module according to a second embodiment in a state in which an upper cover of the battery module is removed; and

FIG. 6 is a plan view of a battery module according to a third embodiment in a state in which an upper cover of the battery module is removed.

### DETAILED DESCRIPTION OF EMBODIMENTS

### First Embodiment

A battery module 11 according to a first embodiment will be described with reference to drawings.

### Overall Configuration of Vehicle 100

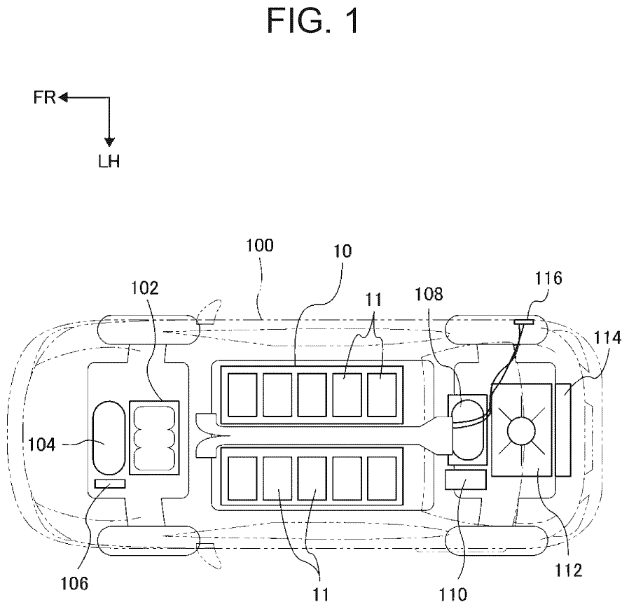

FIG. 1 is a schematic plan view showing a main portion of a vehicle 100 to which a battery module 11 according to the present embodiment is applied. As shown in FIG. 1, the vehicle 100 is a battery electric vehicle (BEV) in which a battery pack 10 is installed under the floor. Note that an arrow UP, an arrow FR, and an arrow LH in each figure indicate an upside in a vehicle-height direction, a frontside in a vehicle front-rear direction, and a left-side in a vehicle width direction, respectively. When description is made by using frontward, rearward, leftward, rightward, upward, and downward directions, unless otherwise specified, they refer to the frontward and rearward directions in the vehicle front-rear direction, the leftward and rightward directions in the vehicle width direction, and the upward and downward directions in the vehicle-height direction.

For example, in the vehicle 100 of this embodiment, a DC/DC converter 102, an electric compressor 104, and a positive temperature coefficient (PTC) heater 106 are arranged to be closer to the front side of a vehicle than the battery pack 10. Furthermore, a motor 108, a gearbox 110, an inverter 112, and a charger 114 are arranged to be closer to the rear side of the vehicle than the battery pack 10.

The voltage of a DC current output from the battery pack 10 is adjusted by the DC/DC converter 102, and then supplied to the electric compressor 104, the PTC heater 106, the inverter 112, and the like. Furthermore, electric power is supplied to the motor 108 via the inverter 112, thereby rotating the rear wheels to cause the vehicle 100 to run.

A charging port 116 is provided at a right side portion of a rear portion of the vehicle 100, and a charging plug of external charging facilities (not shown) is connected from the charging port 116, whereby electric power can be accumulated into the battery pack 10 via the on-board charger 114.

Note that the arrangement, structures, etc. of the respective components constituting the vehicle 100 are not limited to the above-described configuration. For example, they may be applied to a hybrid vehicle (HV) or a plug-in hybrid electric vehicle (PHEV) equipped with an engine. The present embodiment is applied to a rear wheel drive vehicle in which the motor 108 is mounted on the rear side of the wheel. However, the present embodiment is not limited to the rear wheel drive vehicle, but may be a front wheel drive vehicle in which the motor 108 is mounted on the front side of the vehicle. A pair of motors 108 may be installed at the front and rear sides of the vehicle. Furthermore, the vehicle may be equipped with an in-wheel motor in each wheel.

Here, the battery pack 10 is configured to include a plurality of battery modules 11. In this embodiment, as an example, ten battery modules 11 are provided. Specifically, five battery modules 11 are arranged on the right side of the vehicle 100 in the vehicle front-rear direction, and five battery modules 11 are arranged on the left side of the vehicle 100 in the vehicle front-rear direction. Moreover, the respective battery modules 11 are electrically connected to one another.

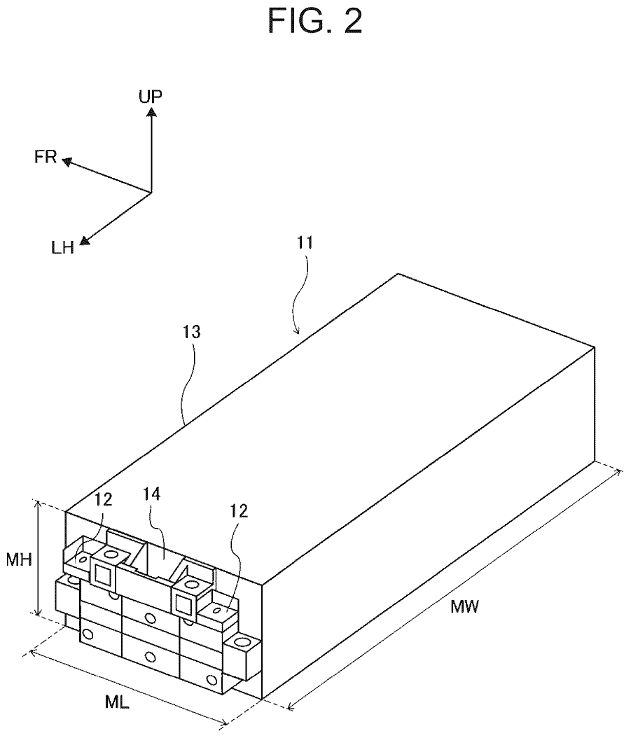

FIG. 2 is a schematic perspective view of the battery module 11. As shown in FIG. 2, the battery module 11 is formed into a substantially rectangular parallelepiped shape whose longitudinal direction is set to the vehicle width direction. Furthermore, a case 13 of the battery module 11 is made of an aluminum alloy. For example, the case 13 of the battery module 11 is formed by joining aluminum die-casting to both end portions of an aluminum alloy extruded material by laser welding or the like.

A pair of voltage terminals 12 and a connector 14 are provided at each of both end portions of the battery module 11 in the vehicle width direction. A flexible printed circuit board 21 described later is connected to the connector 14. Furthermore, bus bars (not shown) are welded to both the end portions of the battery module 11 in the vehicle width direction.

The length MW of the battery module 11 in the vehicle width direction is, for example, 350 mm to 600 mm, the length ML in the vehicle front-rear direction is, for example, 150 mm to 250 mm, and the height MH in the vehicle-height direction is, for example, 80 mm to 110 mm.

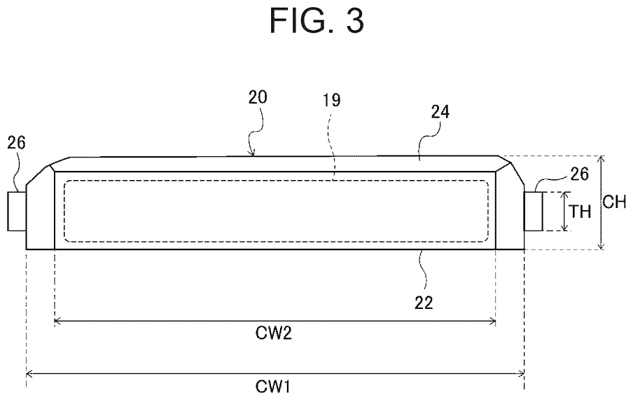

FIG. 3 is a schematic diagram of a battery cell 20 accommodated in the battery module 11 as viewed in the thickness direction. As shown in FIG. 3, the battery cell 20 is formed in a substantially rectangular plate shape, and an elongated electrode body 19 is accommodated therein. The electrode body 19 is configured by laminating a positive electrode, a negative electrode, and a separator, and is sealed with a laminate film 22.

In the present embodiment, as an example, an accommodating portion for the electrode body 19 is formed by folding and bonding an embossed sheet-like laminate film 22. Although it is possible to adopt both of a single cup embossed structure in which embossing is performed at one place and a double cup embossed structure in which embossing is performed at two places, the present embodiment adopts the single cup embossed structure with a draw depth of about 8 mm to 10 mm.

The upper ends of both end portions of the battery cell 20 in the longitudinal direction are folded, and the corners thereof form the outer shape. Furthermore, the upper end portion of the battery cell 20 is folded, and a fixing tape 24 is wrapped around the upper end portion of the battery cell 20 along the longitudinal direction.

Here, a terminal (tab) 26 is provided at each of both the end portions of the battery cell 20 in the longitudinal direction. In the present embodiment, as an example, the terminal 26 is provided at a position which is offset downward from the center of the battery cell 20 in the up-and-down direction. The terminal 26 is joined to a bus bar (not shown) by laser welding or the like.

The length CW1 of the battery cell 20 in the vehicle width direction is, for example, 530 mm to 600 mm, the length CW2 of an area in which the electrode body 19 is accommodated is, for example, 500 mm to 520 mm, and the height CH of the battery cell 20 is, for example, 80 mm to 110 mm. Therefore, the battery cell 20 is formed in an elongated shape, and the directions of the lengths CW1 and CW2 define the longitudinal direction.

Furthermore, the thickness of the battery cell 20 is 7.0 mm to 9.0 mm, and the height TH of the terminal 26 is 40 mm to 50 mm.

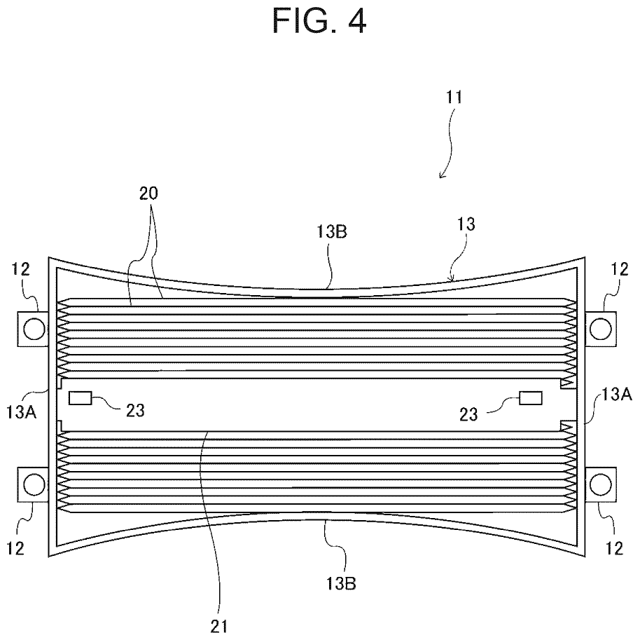

FIG. 4 is a plan view of the battery module 11 according to the first embodiment in a state in which the upper cover according to the first embodiment is removed. As shown in FIG. 4, a battery cell group in which a plurality of battery cells 20 are arranged is accommodated inside the battery module 11. In the present embodiment, as an example, twenty four battery cells 20 are arranged in the vehicle front-rear direction and bonded to one another.

A flexible printed circuit (FPC) 21 is arranged on the battery cell 20. The flexible printed circuit board 21 is formed in a band-like shape whose longitudinal direction is set to the vehicle width direction, and a thermistor 23 is provided at each of both end portions of the flexible printed circuit board 21. The thermistor 23 is not bonded to the battery cell 20, but is configured to be pressed against the battery cell 20 side by the upper cover of the battery module 11.

Furthermore, one or a plurality of buffer plates (not shown) are accommodated inside the battery module 11. For example, the buffer plate is an elastically deformable thin plate-like member, and arranged between adjacent battery cells 20 with the arrangement direction of the battery cells 20 being set to the thickness direction. In the present embodiment, as an example, cushioning materials are arranged at both the end portions of the battery module 11 in the longitudinal direction and at the center portion in the longitudinal direction, but it is not necessary to arrange the cushioning materials.

Here, the case 13 is configured to include a pair of short side wall portions 13A extending along the lamination direction of the battery cells 20, and a pair of long side wall portions 13B that connect the short side wall portions 13A to each other. The long side wall portion 13B is formed in a shape that is more difficult to deform in the plate thickness direction than the short side wall portions 13A.

Specifically, the pair of short side wall portions 13A constituting the case 13 are each formed in a substantially linear shape in plan view. On the other hand, the pair of long side wall portions 13B are each formed in such a shape that a center portion thereof in the longitudinal direction is convex inward. In other words, the pair of long side wall portions 13B are recessed in opposite directions to each other.

Furthermore, in the present embodiment, the center portions of the long side wall portions 13B in the longitudinal direction are in contact with the battery cells 20 (battery cell group) in an unloaded state, and the battery cell group is restrained from both sides by the long side wall portions 13B.

### Action

Next, the action of the battery module 11 according to the present embodiment will be described.

In the battery module 11 according to the present embodiment, the battery cell 20 is formed by sealing the electrode body 19 with a laminate film 22, and has an elongated shape. Furthermore, the case 13 is capable of accommodating the battery cell group in which a plurality of battery cells 20 are arranged. Here, the long side wall portions 13B of the case 13 are formed in a shape that is more difficult to deform in the plate thickness direction than the short side wall portions 13A. As a result, when the battery cells 20 thermally expand, reaction force is applied from the long side wall portions 13B of the case 13 to the battery cells 20, whereby the thermal expansion of the battery cells 20 can be restrained. Furthermore, since the long side wall portions 13B of the case 13 are configured to have a shape that is difficult to deform in the plate thickness direction, thereby restraining the thermal expansion of the battery cells 20, so that there is no need for a dedicated member such as a heat-shrinkable protective layer. In other words, according to the battery module 11 of the present embodiment, thermal expansion can be restrained while suppressing increase in the number of manufacturing steps and the cost.

Furthermore, in the present embodiment, the center portions of the long side wall portions 13B in the longitudinal direction are convex inward. Here, since center portions of the battery cells 20 in the longitudinal direction tend to expand during thermal expansion, it is possible to effectively restrain the thermal expansion of the battery cells 20 by bringing the center portions of the long side wall portions 13B in the longitudinal direction into contact with the battery cell group.

In particular, in the present embodiment, since the long side wall portions 13B are in contact with the battery cells 20 (battery cell group) in an unloaded state, the long side wall portions 13B can apply restraining pressure to the battery cell group.

### Second Embodiment

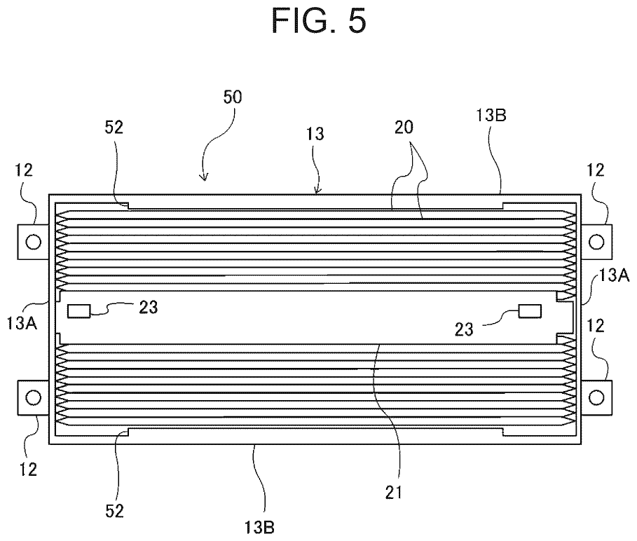

Next, a battery module 50 according to a second embodiment will be described with reference to FIG. 5. Note that the same configurations as those in the first embodiment are given the same reference signs, and the description thereof will be omitted as appropriate.

FIG. 5 is a plan view of a battery module 50 in the present embodiment in a state in which an upper cover is removed. As shown in FIG. 5, in the present embodiment, long side wall portions 13B are formed such that center portions thereof in the longitudinal direction are thicker than the other portions.

Specifically, the case 13 of the battery module 50 of the present embodiment is configured to include a pair of short side wall portions 13A formed in a substantially linear shape in plan view, and a pair of long side wall portions 13B formed in a substantially linear shape in plan view.

Here, each of the long side wall portions 13B has a thick portion 52 formed at a center portion thereof in the longitudinal direction. The thick portion 52 is formed to be thicker than the other portions. For this reason, the long side wall portions 13B are formed in such a shape that the center portions thereof in the longitudinal direction are convex inward. Furthermore, the thick portion 52 is in contact with the battery cell 20 in an unloaded state.

### Action

Next, the action of the battery module 50 according to the present embodiment will be described.

In the present embodiment, since the thick portion 52 at the center portion of the long side wall portion 13B in the longitudinal direction is thicker, the strength thereof is higher than the other portions. As a result, it is possible to reduce the weight as compared with a case in which the entire bodies of the long side wall portions 13B are made thicker while the force from the battery cell 20 is favorably received during thermal expansion of the battery cells 20. The other actions are similar to those in the first embodiment.

### Third Embodiment

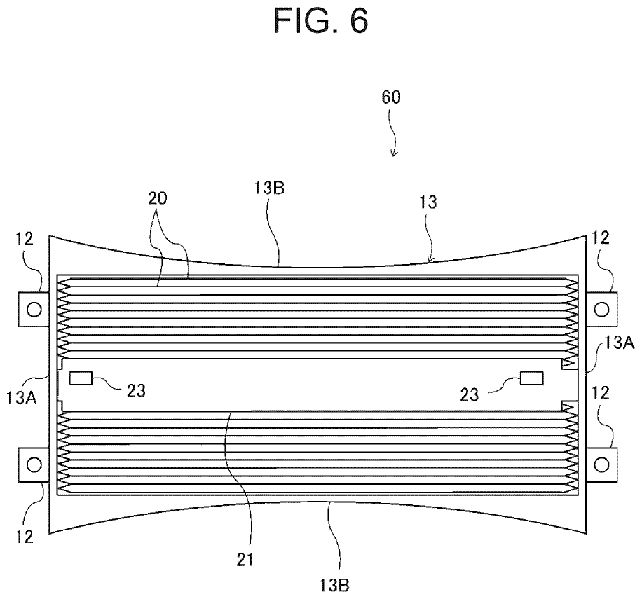

Next, a battery module 60 according to a third embodiment will be described with reference to FIG. 6. Note that the same components as those in the first embodiment are given the same reference signs, and the description thereof will be omitted as appropriate.

FIG. 6 is a plan view of the battery module 60 in the present embodiment in a state in which an upper cover of the battery module 60 is removed. As shown in FIG. 6, in the present embodiment, a connection portion of the long side wall portion 13B to be connected to the short side wall portion 13A is formed to be thicker than the other portions.

Specifically, a case 13 of the battery module 60 of the present embodiment is configured to include a pair of short side wall portions 13A formed substantially linearly in plan view, and a pair of long side wall portions 13B that connect the short side wall portions 13A to each other.

Here, the long side wall portion 13B has such a shape that an outer surface is recessed in the lamination direction of battery cells 20. Furthermore, the inner surface of the long side wall portion 13B is approximately parallel to the battery cell 20. For this reason, the long side wall portion 13B is formed in such a shape that the thickness thereof increases from a center portion thereof to end portions in the longitudinal direction, and it is formed such that a connection portion thereof to be connected to the short side wall portion 13A is thickest.

### Action

Next, the action of the battery module 60 according to the present embodiment will be described.

In the present embodiment, even when a load is applied from the battery cell 20 to the long side wall portion 13B during thermal expansion of the battery cell 20, so that the load is concentrated at the connection portion between the long side wall portion 13B and the short side wall portion 13A, it is possible to suppress deformation because the connection portion between the long side wall portion 13B and the short side wall portion 13A is thicker than the other portions. The other actions are similar to those in the first embodiment.

Although the battery modules 11, 50, and 60 according to the embodiments have been described above, the present disclosure not limited to this style, and it goes without saying that the embodiments can be implemented in various aspects without departing from the gist of the disclosure. For example, in the above embodiments, the center portion of the long side wall portion 13B in the longitudinal direction is in contact with the battery cell 20 in an unloaded state. However, the present disclosure is not limited to this style, and it may be configured such that the long side wall portion is not in contact with the battery cell.

Furthermore, in the first embodiment, the long side wall portion 13B is formed to have such a shape that the center portion thereof in the longitudinal direction is convex inward. However, the present disclosure is not limited to this style, and the long side wall portion 13B may be formed to have such a shape that a portion offset toward the end portion side with respect to the center portion of the long side wall portion in the longitudinal direction is convex inward.

Regarding the above embodiments, the following supplements are disclosed.

### (Supplement 1)

A battery module comprising:
elongated battery cells each formed by sealing an electrode body with a laminate film; and
a case capable of accommodating a battery cell group in which a plurality of the battery cells is arranged, wherein the case is configured to include a pair of short side wall portions extending along a lamination direction of the battery cells, and a pair of long side wall portions that connect the short side wall portions, and the long side wall portions are formed in a shape that is more difficult to deform in a plate thickness direction than the short side wall portions.

### (Supplement 2)

The battery module according to supplement 1, wherein the short side wall portions are formed in a linear shape, and the longitudinal side wall portions are formed in such a shape that center portions thereof in a longitudinal direction are convex inward.

### (Supplement 3)

The battery module according to supplement 1 or 2, wherein center portions of the long side wall portions in the longitudinal direction are in contact with the battery cell group in an unloaded state.

### (Supplement 4)

The battery module according to any one of supplements 1 to 3, wherein the long side wall portions are formed such that center portions in the longitudinal direction thereof are thicker than other portions.

### (Supplement 5)

The battery module according to supplement 1, wherein connection portions of the long side wall portions to be connected to the short side wall portions are formed to be thicker than other portions.

What is claimed is:

1. A battery module comprising:
elongated battery cells each formed by sealing an electrode body with a laminate film; and
a case capable of accommodating a battery cell group in which a plurality of the battery cells is arranged,
wherein the case is configured to include a pair of short side wall portions extending along a lamination direction of the battery cells, and a pair of long side wall portions that connect the short side wall portions, and the long side wall portions are formed in a shape that is more difficult to deform in a plate thickness direction than the short side wall portions.

2. The battery module according to claim 1, wherein the short side wall portions are formed in a linear shape, and the long side wall portions are formed in such a shape that center portions thereof in a longitudinal direction are convex inward.

3. The battery module according to claim 2, wherein center portions of the long side wall portions in the longitudinal direction are in contact with the battery cell group in an unloaded state.

4. The battery module according to claim 1, wherein the long side wall portions are formed such that center portions in the longitudinal direction thereof are thicker than other portions.

5. The battery module according to claim 1, wherein connection portions of the long side wall portions to be connected to the short side wall portions are formed to be thicker than other portions.
